(19) United States
(12) Patent Application Publication
(10) Pub. No.: US 2016/0107511 A1
(43) Pub. Date: Apr. 21, 2016

(54) DOOR IMPACT BEAM FROM AN EXTRUSION PROFILE AND ITS MANUFACTURING PROCESS

(71) Applicant: Benteler Automobiltechnik GmbH, Paderborn (DE)

(72) Inventors: Edvin List CLAUSEN, Lojt Kirkeby Abenra (DK); Jochem GREWE, Salzkotten (DE); Joern TOELLE, Paderborn (DE); Martin SCHROETER, Paderborn (DE); Gero MUELLERS, Paderborn (DE); Dariusz STRAZNIKIEWICZ, Paderborn (DE)

(21) Appl. No.: 14/885,480

(22) Filed: Oct. 16, 2015

(30) Foreign Application Priority Data
Oct. 17, 2014 (DE) 102014115158.5

(51) Int. Cl. B60J 5/04; C22F 1/00

(52) U.S. Cl. CPC B60J 5/0448; B60J 5/0483; B60J 5/0463; B60J 5/0456; C22F 1/002

(57) ABSTRACT

The present invention comprises a door impact beam (1) of a vehicle door and a method for its production. The door impact beam (1) according to the present invention is made from a multi-chamber extrusion hollow profile out of a light metal alloy and formed as one-piece and materially uniform component. The door impact beam (1) comprises lengthwise (L) a Y-shaped contour with two protruding arms (2) and a base (3).

The present invention comprises a door impact beam for a vehicle door according to the features in patent claim 1.

The present invention further comprises a method for manufacturing a door impact beam according to the features in patent claim 12 as well as claim 13.

From prior art self-supporting vehicle bodies are known. In these self-supporting vehicle bodies openings are provided, so that a passenger can get inside the vehicle. These openings are usually closed by a vehicle door pivoting around a vertical axis. Sliding or folding doors are also known from prior art. There is a potential weak spot in the middle area of the vehicle door.

There is a lateral vehicle sill in the lower area and a roof post in the upper area, however if an impacting object were to hit the middle area of the vehicle door, which consequently is between the vehicle occupant's pelvis and shoulder, it would not meet a reinforced structure, and thus could break through into the interior.

Door impact beams are therefore known for preventing this. A door impact beam is a reinforcing component, which essentially extends lengthwise into the vehicle and is used in the area of a vehicle door.

Based on prior art, it is known that door impact beams are made of steel, but also of light metal or fiber composite material.

For example, a molded door impact beam for a vehicle is known from DE 20 2012 002 264 U1. To this end, a door impact beam made of extrusion profile construction is proposed, in particular however, roll forming will be set up to manufacture the door impact beam cross section profile.

From prior art, the object of the present invention is therefore, to present a door impact beam that is light weight with improved crash performance at a low production cost.

The above object is achieved according to the present invention by a door impact beam for a vehicle door according to the features in patent claim 1.

A procedural part of the object is achieved with a method for producing a door impact beam having the features in patent claim 12.

An additional procedural approach is shown again in the features of claim 13.

Advantageous design variants of the present invention are described in the respective dependent claims.

The door impact beam of a vehicle door according to the present invention, is made from a light metal alloy, multi-chamber extrusion profile as a one-piece materially uniform component, wherein the door impact beam has a longitudinal Y-shape or multi-arm contour with at least two separate protruding arms and a base.

The door impact beam is then installed in a vehicle door in particular and connected to it. The connection in particular is done by bolting or riveting, but the door impact beam may also be glued or welded into the vehicle door. The Y-shaped contour means that in the installed position the door impact beam significantly extends into the vehicle with its longitudinal direction in the longitudinal direction of the vehicle and is designed such that two protruding arms form the fork of the Y. These are essentially fitted at an angle to the longitudinal direction of the vehicle. The lower part of the letter Y forms a base, which then extends from the Y-fork point of the arms in the opposite direction of the arms. This base is also preferably oriented lengthwise or at an angle hereto. The door impact beam is preferably mounted in a slightly rear-sloping position relative to the direction of travel.

The door impact beam according to the present invention yields the following advantages. With the Y-shaped contour it is possible to engage stiff reinforcement at all three conventional connection points of a pivoting vehicle door in the event of a side impact. Thus, the two free ends of the arms are preferably positioned at the height of the door hinges and the end of the base is positioned near the door lock. For a front door, the two free arms of the Y would be fitted near the A-pillar at the hinge connection points and the free end of the base near the B-pillar preferably at the door lock. In the event of a side impact, the door impact beams supports all three aforementioned support points due to the Y-shaped contour.

By building a multi-chamber hollow profile, the door impact beam is particularly light weight with high rigidity against bending in the cross direction of the vehicle. Using an extrusion profile construction format and subsequent processing for bending and/or forming, also allows very cost-effective production of each door impact beam, since a more expensive, roll forming process for producing a cross-section contour is not necessary.

The door impact beam according to the present invention has the same advantages with a multi-arm contour in the event that there are multiple arms, in particular two, on one end of the base as well as on the opposite end. In addition, there is the advantage that the Y-contour or other arms provide further support functions, in particular at an angle to the longitudinal direction of the vehicle, in particular reinforcement in the vertical direction the number of separate reinforcing components in the door can be reduced.

The door impact beam is designed as a two-chamber hollow profile in particular and preferably as a three-chamber hollow profile. Initially a corresponding extrusion multi-chamber hollow profile is cut to length and then the arms are cut in. This is preferably done in a three-chamber hollow profile, wherein the center chamber is separated lengthwise which essentially corresponds to the length of the yet to be manufactured arms. The arms are then separated using a bending process that creates the Y-contour or multi-arm contour. The original hollow chambers of the extrusion profile extend from the Y-fork point over a center segment to form the base.

At the free end of the base a connecting point is provided preferably for coupling or installation in the vehicle door. This can be done in particular by flattening the end or by simple flat compression of the end. This results in the advantage that the door impact beam is more flat within the installation space, thus in the area of a laterally revolving door frame and can therefore save space when connected to the door frame. Because the hollow chambers extend across the surface of the door impact beam, this creates high rigidity and a high section modulus against bending, in particular in the cross direction of the vehicle while being light weight at the same time. The arms each have a hollow chamber and are also preferably flattened at their ends for connection or installation in the vehicle door.

It is particularly appropriate to produce the door impact beam with 6000 or 7000 aluminum alloy. It can be annealed after the extrusion profile is cut to length and then formed with a relatively high degree of freedom. A subsequent combination of artificial and natural aging treatment makes it possible to set the specifically required strength properties.

Furthermore, the door impact beam may include two arms at each end or on each side, which extend out from the base in different directions to each other, wherein at least one arm is near the height of the door hinge and one of the opposed arms is near the height of the door lock when installed. The door impact beam would thus be formed in an X shape. The door impact beam may also be formed in a T-shape or double T-shape.

Further description will be made for the Y-contour or multi-arm contour, to the extent useful synonyms are used, so that reference to two arms, Y-fork point and the multi-arm configuration is understood.

In another particularly preferred embodiment, the multi-chamber extrusion hollow profile has different wall thickness in cross-sectional areas opposite each other. The extrusion technology makes it possible to set the specific wall thickness in a simple and cost-effective manner by way of the extrusion process. Preferably, the connecting bases between the chambers have a greater wall thickness, as that is where the section modulus increases against a bending force in the cross direction of a vehicle. The lateral stiffness of the door impact beam according to the present invention is thereby increased significantly. The advantage of using extrusion technology with door impact beams according to the present invention is that the number of components and joining operations is reduced, especially compared to steel solutions.

In another particularly preferred design variant of the present invention, the door impact beam has a changing cross-section from the Y-fork point to the individual base, whereby the cross-section in particular is reduced in height and increased in width. This also increases the lateral rigidity. The changing cross-section shall be achieved through a three-dimensional compression molding after producing the extrusion profile. In combination with different wall thickness opposite each other, this provides the optimum weight and rigidity or crash performance. Other forming methods are conceivable such as hydroforming, for example.

Another particularly preferred design variant of the door impact beam according to the present invention, provides that one end of at least one arm in an end piece, is bent pointing in the vehicle vertical direction in particular at an angle greater than 50°, preferably more than 60°, in particular more than 70° and most preferably at 90° or more than 90°. The bending is carried out towards the bottom relative to the vehicle vertical direction, thus pointing towards the street in a vehicle. This makes it possible to use the bent end portion of the door impact beam to reinforce the hinge area in particular. Thus, a vehicle door hinge, particularly a hinge that is bolted or riveted to the vehicle door, may be bolted together with the end piece of the door impact beam, wherein the end piece then provides corresponding hinge reinforcement. Within the scope of the invention, this is of course also possible on the other side, so that corresponding reinforcement for the lock is formed by a bent end part at the end of the base.

The possibility of integrated hinge or lock reinforcement can be further improved in that a materially uniform one-piece protruding flange is formed on the end pieces of the arms laterally to the longitudinal side of the door impact beam. Thus the flange provides a better mounting surface for the bolts in attaching the door hinge for example. The flange also serves as the connection for means of attachment and/or provides an increased surface area for welding and/or gluing, etc.

A further advantageous design variant of the door impact beam according to the present invention provides that the area at the end of the base is formed in a three-chamber hollow profile in such a way that the two outer chambers, an upper and a lower chamber relative to the vehicle vertical direction, are flattened and/or cut off at an angle and the middle chamber extends continuously to the end. This makes it possible to provide a corresponding bolting or attachment point, with the door fame for example, for the two outer chambers. However, the middle chamber which extends continuously to the end, provides sufficient rigidity against bending in the vehicle transverse direction.

The above object is further achieved by a method for manufacturing a door impact beam according to the features in patent claim 12, whereby the method comprises the following steps:
Supply a multi-chamber hollow profile as an extrusion profile made of light metal,
Cutting the extrusion profile,
Cutting the extrusion profile section lengthwise for a length which essentially corresponds to the length of the Y-shaped arms, whereby two hollow chambers are separated from one another so that each arm has a hollow chamber,
Bending the arms apart to the Y-shaped contour of the door impact beam.

In particular, a two-chamber hollow profile is used, most preferably a three-chamber hollow profile. The cut to length extrusion profile is cut from one end, so that the at least two hollow chambers are separated. For a three-chamber hollow section, the middle chamber is cut. The resulting arms are bent apart in a subsequent step, so that the door impact beam has a Y-shaped contour and is produced as a materially uniform one-piece component made of light metal.

Preferably, the door impact beam is then formed three-dimensionally, in particular compression-molded, wherein the cross section in particular can by changed by compression molding in the longitudinal direction. Furthermore, the door impact beam is more preferably bent in an arch along its length, in particular, curved in an arch outward relative to the vehicle transverse direction.

An alternative or complementary method for manufacturing a door impact beam provides the following process steps according to claim 13:
Supply a multi-chamber hollow profile as an extrusion profile made of light metal with at least one materially uniform one-piece flange protruding laterally to the longitudinal side.
Cutting the extrusion profile to length and partially separating the flange lengthwise,
Bending at least one end piece by more than 50 degrees, in particular more than 80 degrees in the vehicle vertical direction, whereby the flange protrudes laterally on the bent end piece, preferably, the flange is oriented in the direction of a bending line.

The bent end piece is used to make a materially uniform one-piece reinforcing component on the door impact beam, which reinforces the hinge on one side, and/or reinforces the lock on the opposite side. When manufacturing a door impact beam with Y-shaped contour, it is possible to bend the two end pieces of the Y-shaped arms so that there is reinforcement at both hinges and/or reinforcement at the lock on the opposite end of the base. Here, the partially separated flange has direct utilization, thereby reducing material use. Because the light metal separates well, splitting the extrusion profile to manufacture the door impact beam will not require a high energy input.

The laterally protruding flange can be angled again and/or be supplied with mounting holes depending on the vehicle door requirements. With the additional door reinforcement and the ability to mount to the laterally protruding flange, it is also possible according to the present invention, to not only improve crash performance at a lower weight, but also to avoid bending the door relative to the vehicle vertical direction. This is particularly necessary with an opened door, if for example, a driver leans on the end of the door or the door moves up and down with the vehicle, but it especially counteracts over-bending the door hinge or the connection to the door frame when it is forcefully swung open.

Additional procedural steps according to the present invention, which can optionally be performed individually or in combination, are that, before, during or after the three-dimensional compression molding, the ends are flattened and before, during or after the flattening of the ends, the ends can be punched at the same time to create mounting holes.

Furthermore, particularly preferable is that the bending and/or compression molding is carried out at with a previous solution annealed semi-fished part, whereby it is quenched before, during or after compression molding and then the desired target rigidity is set in a combined artificial and natural aging process. Furthermore, particularly preferable is that is that the component is cut, punched and/or stamped between or after the individual process steps.

Further advantages, features, characteristics and aspects of the present invention are the subject of the following description. Preferred design variants are shown in the schematic illustrations. These provide simple understanding of the invention. Shown are:

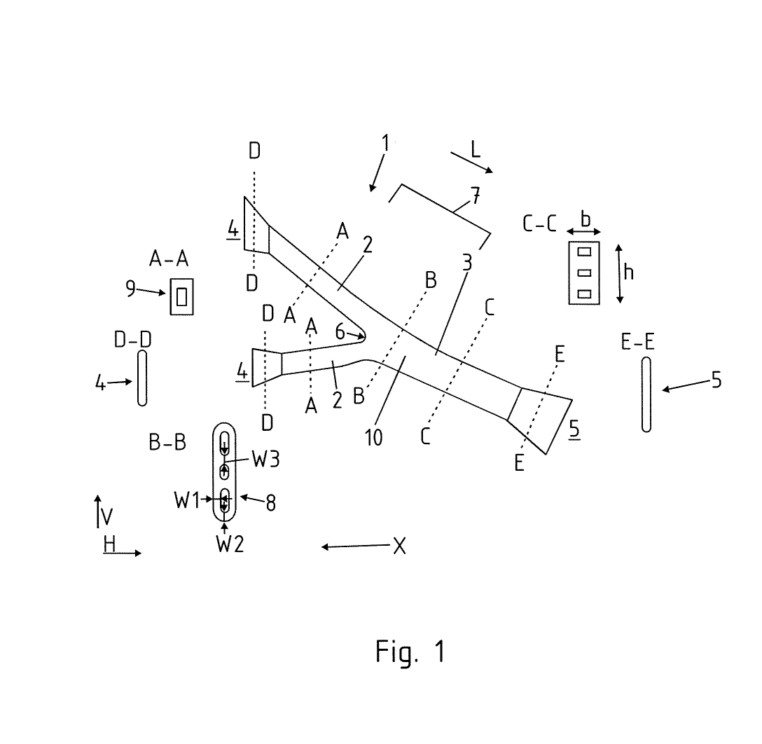

FIG. 1 Door impact beam side view with sectional representation according to the present invention,

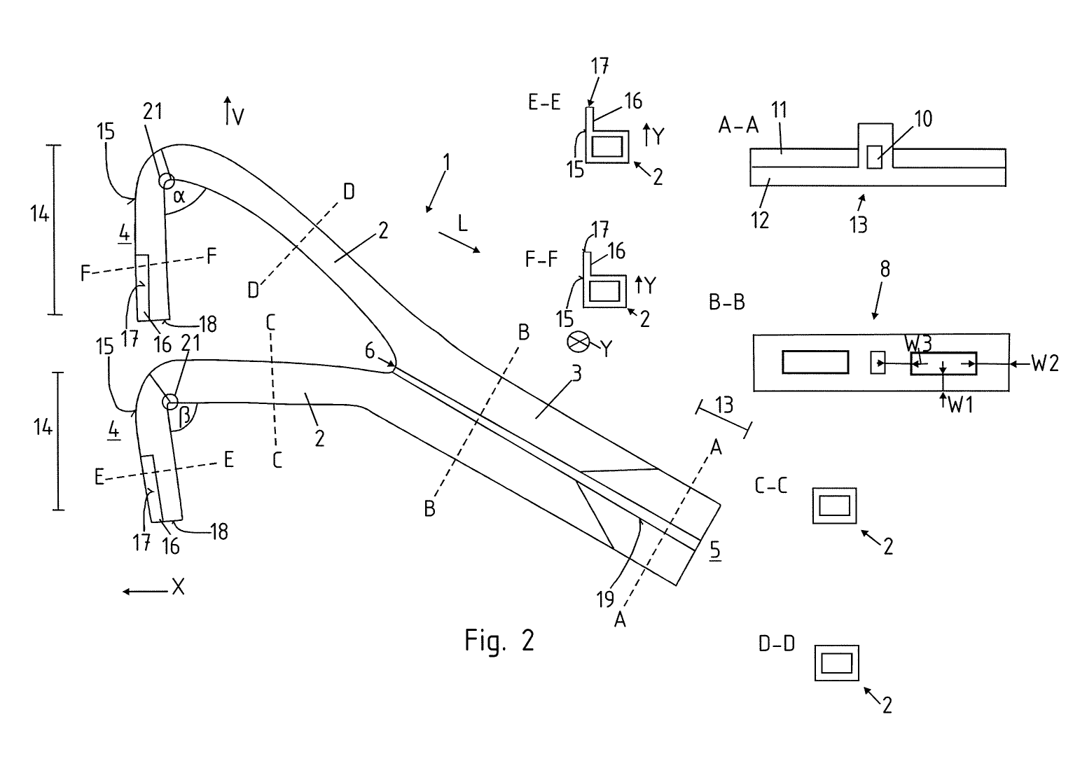

FIG. 2 shows an alternative embodiment variant,

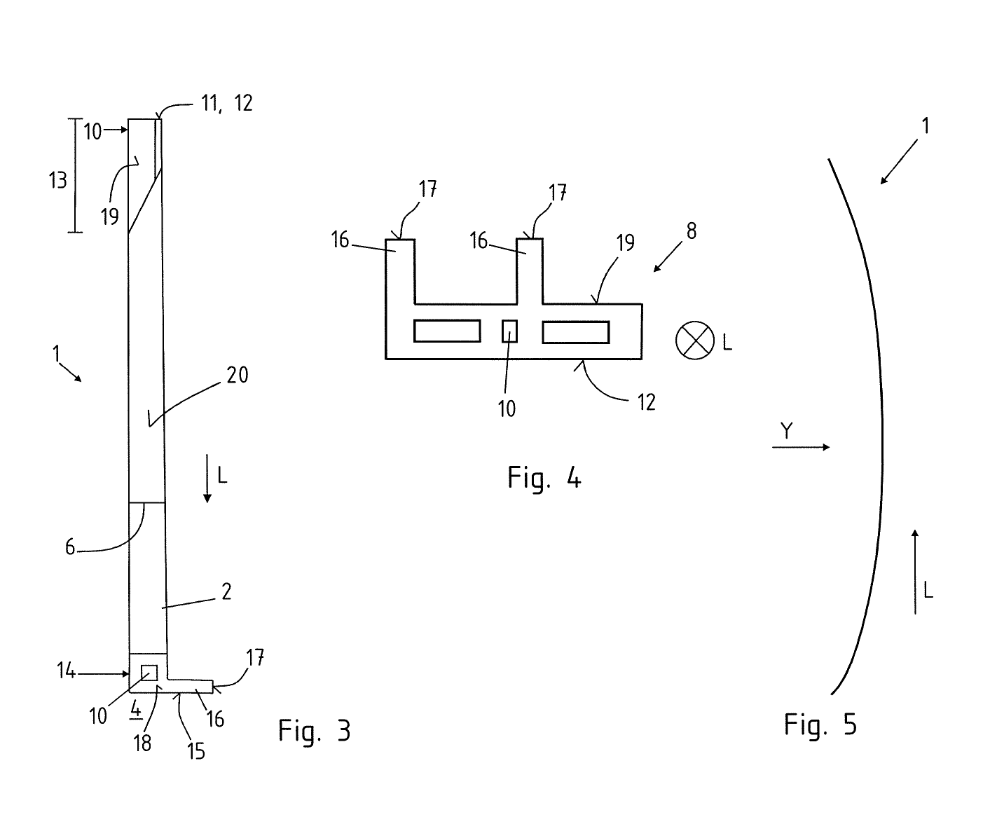

FIG. 3 shows a bottom view of the door impact beam according to FIG. 2,

FIG. 4 shows a cross section through an extrusion profile for the production of a door impact beam according to the present invention according to FIG. 2,

FIG. 5 shows a top view of a door impact beam with a bend in the vehicle transverse direction and

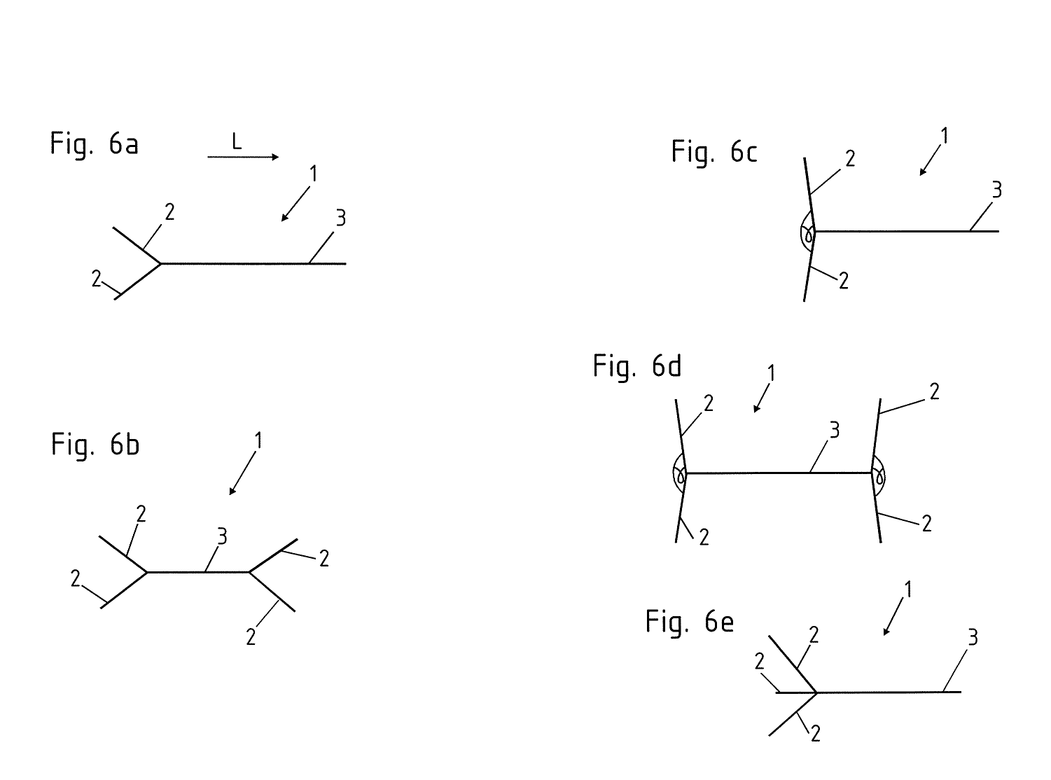

FIG. 6a to e different contour views of a door impact beam according to the present invention.

FIG. 1 shows a door impact beam 1 according to the present invention with a Y-shaped contour in the longitudinal direction. The Y-shaped contour has two arms 2 and a base 3. The arms 2 each have a free end 4 and the base 3 has a free end 5 opposite the arms 2 free end. The door impact beam 1 is bent apart in a Y-fork point 6 so that the Y-fork forms the two arms 2. The door impact beam 2 is formed out of a three-chamber hollow profile in the form of an extrusion profile along the section line B-B in a middle section 7 of the door impact beam 2. The extrusion profile has a cross section of three hollow chambers each with different wall thickness w1, w2, w3. The wall thickness w1 of the walls, which are oriented in a vertical direction V are thinner compared to the wall thickness w2 of the walls in a horizontal direction H. Thus, the wall thickness w1 is less than the wall thickness w2 and also less than the wall thickness w3. The wall thickness w2 and w3 may also differ from each other, for example, the wall thickness w2 can be less than the wall thickness w3.

According to the section line C-C the multi-chamber hollow profile 8 is changed in the cross section. It has been reduced in height h and increased in width b. Here, the wall thickness w1, w2, w3 change accordingly. The change of the cross section is carried out by the three-dimensional compression molding process according to the present invention. The end 5 of the base 3 is flattened along the section line E-E, which is made possible by a flattening or compressing the end 5. The same applies to the ends 4 of the arms 2, shown in section line D-D. Section line A-A comprises an arm 2, each with only one single chamber hollow profile 9. This single chamber hollow profile 9 is made by separating the non-illustrated piece lengthwise L from the ends 4 of the arms 2 to the middle chamber 10 for manufacturing a door impact beam 1, so that the middle chamber 10 is opened and the connecting arms 2 are bent apart. According to the side view of FIG. 1, the separating lines between the upper, middle and lower chamber are shown schematically and, according to FIG. 5, the door impact beam 1 can have a bend lengthwise L in the vehicle drive direction Y using the three-dimensional compression process.

An alternative embodiment variant of the door impact beam 1 according to the present invention is illustrated in FIG. 2. Here, the door impact beam 1 also has a Y-shaped contour lengthwise L at the ends of arms 2 and a base 3 extending from the arms 2. Again, the door impact beam 1 is made along section line B-B at a middle portion 7 from a three-chamber hollow profile having different wall thickness w1, w2, w3. As used herein, “lengthwise” corresponds with the longitudinal direction of the beam.

The end 5 the base 3 is not completely flattened, but comprises the middle chamber 10 continuously on to the end along the section line A-A. The two outer chambers are separated lengthwise L and then compressed. Thus, an upper wall 11 and a lower wall 12 lie against each other. This allows the possibility of creating an attachment point at the end section 13 of the free end 5 of the base 3, whereby a corresponding gain in vehicle direction Y is produced by the solid middle chamber 10. The middle chamber 10 is separated lengthwise L from the Y-fork point 6 and the two arms 2 are bent. This produces the cross-sectional view along C-C and D-D of the arms 2.

In contrast to the door impact beam 1 shown in FIG. 1, here is an end piece 14 of the respective arm 2 along a bending line 21 in a corresponding angle α and β of more than 50°, in particular more than 60°, preferably more than 70°, wherein angle α and angle β can be different from each other, bent downward, in particular in the vertical direction V. The bending line 21 extends essentially parallel to the vehicle direction Y. This makes it possible for each bent end piece 14 to be attached in vehicle direction X to the front side 15, for example, from the inside to a door frame panel for connecting with a door hinge.

Furthermore, a materially uniform one-piece protruding flange (16) is formed laterally to the longitudinal side, according to the present invention. The flange 16 allows the possibility for enlarging or widening the mounting surface in vehicle direction Y and provides a corresponding enlarged attachment on the front side 15. Thus the flange 16 makes it possible to, for example, better bolt or attach the door impact beam 2. Also, the flange 16 may be bent further towards the respective chamber of the arms. 2 A front surface 17 of the flange 16 can be fitted pointing outwards or inwards relative to the vehicle direction Y. It is also conceivable that the flange 16, as shown here, only partially extends over the end piece and thus the door impact beam 2 can be form-fitted into a door frame panel with the flange 16.

Also clearly visible in FIGS. 1 and 2 is that the door impact beam 1 is mounted into position at a rear sloping angle relative to the vehicle direction X. However, it would also be possible, to align the door impact beam 1 completely horizontal, so that the base 3 is oriented essentially in horizontal direction H, and then the Y-arms 2 are arranged at an angle thereto. For a back door, the setup of the door impact beam in reverse to the direction of travel may be used.

FIG. 3 shows the door impact beam 1 from FIG. 2 in a view from below. Here, the bottom side 18 of the end piece 14 of the bent arm 2 is again clearly visible. Furthermore, the lower arm 2 is shown which runs from fork point 6 in a bend towards the end 4 of the arm 2. Also clearly visible is the end section 13 with a view to one side 19 of the middle chamber 10.

Shown in FIG. 4 is the cross-section of a multi-chamber hollow profile 8, which initially serves as an extrusion profile for production of the door impact beam 1. This multi-chamber hollow profile 8 has three chambers which extend the entire length of the profile. These laterally protruding flanges 16 are then separated lengthwise L and left only in the end section 14 or in a part of the end section 14. The separated parts can then be delivered directly for re-use.

FIG. 6a shows the door impact beam 1 according to FIG. 1 or FIG. 2, in a schematic view. This comprises lengthwise L a Y-shaped contour. It is also possible according to FIG. 6b both opposite ends of the door impact beam 1 respectively to be Y-shaped, resulting in an overall X-shaped contour lengthwise L to the door impact beam 1.

The respective arms 2 may also be formed according to FIG. 6c at such an angle γ, that the angle γ is in a range between 160° and 180°. According to FIG. 6d, this can also be formed as a double T-shape, so that the angle γ is formed on both sides of the arms 2.

FIG. 6e shows another alternative embodiment variant with one side of the door impact beam 1 three arms 2. The three arms 2 are in the form of a trident, wherein two outwardly standing arms 2 are protruding, similar to the Y-shaped contour and a middle arm 2 extending essentially lengthwise L as an extension of the base 3. However, the middle arm 2 can also extend over the base 3 at an angle.

### REFERENCE SYMBOLS

1. Door impact beam
2. Arm
3. Base
4. End to 2
5. End to 3
6. Fork point
7. Middle section
8. Multi-chamber hollow profile
9. Single chamber hollow profile
10. Middle chamber
11. Upper wall
12. Lower wall
13. End section to 5
14. End section to 4
15. Front side
16. Flange
17. Front surface to 16
18. Bottom side to 14
19. Side to 10
20. Bottom side to 1
21. Bending line
α—angle
β—angle
γ—angle
L—Lengthwise
h—height
b—width
w1—wall thickness
w2—wall thickness
w3—wall thickness
V—Vertical direction
H—Horizontal direction
X—Vehicle direction X
Y—Vehicle direction Y

1. A door impact beam (1) made from a light metal alloy, multi-chamber extrusion profile (8) as a one-piece and materially uniform component, wherein the door impact beam (1) has a Y-shape lengthwise (L) or multi-arm contour with at least two separate protruding arms (2) and a base (3).

2. A door impact beam according to claim 1, wherein the arms (2) comprise a hollow chamber in each cross-section, whereby the base (3) comprises two, more particularly three hollow chambers in the cross section.

3. A door impact beam according to claim claim 1, wherein the end (4) of each arm (2) is positioned at the height of a door hinge in the installed state.

4. A door impact beam according to claim 1, wherein
a corresponding end (4, 5) of the arms (2) and/or of the base (3) has a flattened form.

5. A door impact beam according to claim 1, characterized
by being made from a 6000 or a 7000 aluminum alloy.

6. A door impact beam according to claim 1, wherein the multi-chamber extrusion hollow profile cross-section is comprised of different wall thickness (w1, w2, w3) opposite each other.

7. A door impact beam according to claim 1, wherein
the cross-section changes from the Y-fork point (6) toward the individual base (3), in particular, the cross-section is reduced in height (h) and the cross-section is increased in width (b).

8. A door impact beam according to claim 1, wherein one end (4) of at least one arm (2) in an end piece (14), especially the ends (4) of both arms (2), is/are bent at an angle (α, β), particularly downward, of more than 50 degrees in the vehicle vertical direction (V), preferably at the bending line (21).

9. A door impact beam according to claim 8, wherein the bent ends are designed to reinforce the door hinge.

10. A door impact beam according to claim 8, wherein a one-piece materially uniform flange (16) is formed on the end portions of the arms (2) that protrudes laterally to the longitudinal side.

11. A door impact beam according claim 1, wherein the two outer chambers are flattened and/or cut at an angle in the area of the end (5) of the base (3) and wherein the middle chamber (10) extends continuously to the end.

12. A process for manufacturing a door impact beam according to claim 1, characterized by the following process steps
Supplying a multi-chamber hollow profile (8) as an extrusion profile made of light metal,
Cutting the extrusion profile to length,
Cutting the extrusion profile section lengthwise (L) for a length section which essentially corresponds to the length of the Y-shaped arms (2), whereby two hollow chambers are separated from one another so that each arm (2) comprises a hollow chamber,
Bending apart of the arms (2) to the Y-shaped or multi-arm contour of the door impact beam (1).

13. A process for manufacturing a door impact beam particularly according to claim 12, characterized by the following process steps:
Supplying a multi-chamber hollow profile (8) as an extrusion profile made of light metal with at least one materially uniform one-piece flange (16) protruding laterally lengthwise (L),
Cutting the extrusion profile to length and partially separating the flange (16) lengthwise (L),
Bending along a bending line 21 of at least one end piece (14) of the cut extrusion profile by more than 50 degrees, in particular more than 80 degrees in the vehicle vertical direction, whereby the bent end portion (14) of the flange (16) protrudes laterally.

14. A method according to claim 12, wherein the door impact beam (1) is optionally compression molded with a three-dimensional Y-shaped contour, wherein the cross-sectional shape is changed lengthwise (L) and/or the door impact beam (1) is bent in an arch shape over its length.

15. A method according to claim 12, wherein during or after the three-dimensional molding, the ends (4, 5) are flattened and optionally punched before or after flattening, and wherein the three-dimensional compression, flattening and punching steps are done in particular by a combined compression molding step.

16. A method according to claim 12, wherein the bending and/or the compression forming is carried out previously with a solution annealed semi-fished part, whereby it is quenched and subsequently set to age naturally and artificially.

17. A method according to claim 12, wherein cutting and/or punching and/or stamping may be done between or after the individual process steps.
